(19) United States
(12) Patent Application Publication
(10) Pub. No.: US 2010/0256943 A1
(43) Pub. Date: Oct. 7, 2010

(54) CONFIGURATION OF INITIAL CONTROL PARAMETERS IN PHOTODETECTORS FOR MULTI-COLOR FLOW CYTOMETRY

(75) Inventors: Albert David Donnenberg, Pittsburgh, PA (US); Vera Svobodova Donnenberg, Pittsburgh, PA (US)

Correspondence Address: Kegler, Brown, Hill & Ritter, 600 Superior Ave. East, Suite 1300, Cleveland, OH, 44114, US

(73) Assignee: University of Pittsburgh - of the Commonwealth System of Higher Education, Pittsburgh, PA (US)

(21) Appl. No.: 12/752,387

(22) Filed: Apr. 1, 2010

Related U.S. Application Data
(60) Provisional application No. 61/167,000, filed on Apr. 6, 2009.

(51) Int. Cl. G12B 13/00; G06F 19/00

(52) U.S. Cl. 702/104; 250/252.1

(57) ABSTRACT

System(s) and method(s) for initial configuration of photodectors in a multi-color flow cytometer to mitigate spectral compensation. Configuration is iterative and automated, and optimizes calibration of control parameters or amplification control parameters subject to constraints that ensure satisfactory, e.g., optimal or within predetermined threshold(s), spectral compensation. Iterative configuration can include at least a first loop for constrained minimization of spectral overlap for a set of operational condition, and a second loop for configured settings acceptance.

This application claims the benefit of U.S. Provisional Patent application Ser. No. 61/167,000 entitled “CONFIGURATION OF INITIAL CONTROL PARAMETERS IN PHOTODETECTORS FOR MULTI-COLOR FLOW CYTOMETRY” and filed Apr. 6, 2009. The entirety of the above-noted application is incorporated by reference herein.

### TECHNICAL FIELD

The subject innovation relates generally to flow cytometry and, more particularly, to calibration of detection instruments in multi-color cytometry through initialization of control parameters in photodetectors for each fluorescence parameter.

### BACKGROUND

Flow cytometry has substantially advanced research and development on disease diagnostic, drug development, soft tissue analysis, vaccine development, study of cellular expression, cell sorting, and so forth. A substantive part of the development has originated in advances in photodetection and multi-color probing. Yet, advantages of multi-color flow cytometry dwindle as the number of colors, or fluorochromes, employed in probing cells and other soft tissue and particles increases. Spectral overlap, or spectral spillover, is present in most multi-color experiments since fluorochromes typically exhibit broad spectral tails in their emission spectra. Thus, advantages associated with capability(ies) to probe, for example, various cellular sites or expressions through multi-color cytometry is hindered by sophisticated ad-hoc correction to collected fluorescence data. In addition, hardware solutions to multi-color spectral overlap are marginally available. Thus, mitigation of spectral overlap remains a significant roadblock to advantageous utilization of multi-color flow cytometry.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

The subject innovation provides system(s) and method(s) for configuration of initial control parameters or amplification control parameters (ACPs) of a plurality of photodectors with digital electronics utilized in a multi-color flow cytometer. For a photodetector that is a photomultiplier device, amplification is controlled by modulating the voltage applied to the photomultiplier device. Configuration is iterative and optimizes calibration of amplification control parameters subject to constraints that ensure satisfactory, e.g., optimal, spectral compensation. In an aspect, iterative configuration can include at least a first loop for constrained minimization of spectral overlap for a set of operational condition, and a second loop primarily being an acceptance loop. At least four criteria can be defined and utilized in calibration: (i) At least a predetermined, configurable portion of unstained events are on-scale, which affords an accurate measurement of median or mean fluorescence intensity of unstained events; (ii) The brightest stained events are on scale; (iii) Spectral compensation between all fluorescence channels is minimized with no spectral matrix coefficients, or spillover coefficients, above a predetermined configurable threshold; and (iv) A spillover metric that assesses an overall degree of spectral overlap in multi-color photon emission measurements is minimized with restriction to criteria (i)-(iii); the spillover metric can be, for example, the sum of squares of spillover coefficients each multiplied by 100.

A calibration component that includes at least one of control component and an analysis component, and an associated processor(s) and memory, automate the iterative calibration. Analysis component can further include at least one of a regression component or an optimization component. The regression component can allow determination of response functions of photodetectors that are being calibrated, and can enable prediction of fluorescence signal strength based at least in part on the determined response function. Such predictions allow assessment of one or more calibration criteria (i)-(iv). Optimization component can determine update strategies for calibrated ACPs based at least in part on one or more approaches to minimization of a computed spillover metric. Control component can communicate with photodetectors and configure specific ACPs in accordance with the automated iterative calibration method.

Aspects and features of the subject innovation illustrate, at least in part, that the relationship between photomultiplier (PMT) voltage and observed fluorescence intensity can be effectively used to predict spillover matrices, or spectral overlap matrices, for a specific set of voltage settings and fluorochromes in order to determine an optimal, or nearly optimal, set of voltages that minimizes spectral compensation and therefore maximizes or substantially maximizes detection of dim fluorescent signals.

At least one advantage of the features or aspects of the subject innovation is that automatic iterative calibration of ACPs can enable spectral overlap minimization, or substantial mitigation, for operation of multi-color flow cytometers with a set of two or more, e.g., ten, photodetectors. Compared to conventional systems and approaches to spectral compensation, the subject innovation can intrinsically address the rapidly increasing number of fluorescence parameters associated with increasing number of detectors in a multi-color cytometer. Moreover, automation of calibration of detection instruments in a flow cytometer largely avoids human intervention and consequent differences in instrument sensitivity stemming from different user-determined choices of detector amplification, thus allowing a more ubiquitous utilization of flow cytometry in clinical analysis and diagnosis.

At least another advantage of the features or aspects of the subject innovation is that calibration described herein can enable standardization of performance of disparate multi-color flow cytometer that utilize one or more sets of fluorochromes (e.g., dyes, antigens, colloidal quantum dots, etc.).

At least another advantage of features and aspects of automatic calibration of initial set of operational parameters of photodetectors described herein is that flow cytometers with disparate photodetectors can be readily calibrated; utilization of disparate classes of detectors can be warranted in situations in which fluorochromes suitable for probing specific proteins, lipids, soft tissue, or cells, and condition thereof, have a low quantum yield for photon emission.

The following description, the annexed drawings and appendices set forth, in detail, certain illustrative aspects of the innovation. These aspects are indicative, however, of but a few of the various ways in which the principles of the innovation may be employed and the subject innovation is intended to include all such aspects and their equivalents. Other objects, advantages and novel features of the innovation will become apparent from the following detailed description of the innovation when considered in conjunction with the drawings.

### BRIEF DESCRIPTION OF THE DRAWINGS

FIG. 1 illustrates a high-level block diagram of an example system for optimizing a set of initial amplification control parameters for each detector in a set of detectors for multi-color, multi-channel flow cytometry in accordance with aspects described in the subject innovation.

FIG. 2 sketches logic blocks associated with calibration of detection instruments in accordance with aspects disclosed in the subject innovation.

FIG. 3 displays a set of observed fluorescence signal strengths as a function of voltage applied to the detector that collects photoemission signal for control samples measured with a set of respective photodetectors that probe fluorescence in specific fluorescence channels in accordance with aspects described herein.

FIG. 4 displays a block diagram of an example embodiment of an analysis component that is part of example calibration system described in the subject innovation.

FIG. 5 illustrates regression coefficients that determine a relationship among a photodetector and probed fluorescence signal strength in a fluorescence channel in accordance with the equation specified in FIG. 3 and aspects described herein.

FIG. 6 illustrates an example spectral overlap matrix (top table) extracted from measured fluorescence of single stain control beads (bottom table), and associated fluorescence signal strengths in accordance with aspects described herein. Red-shaded cells indicate spillover coefficients greater than 40%.

FIG. 7 displays a set of adjusted voltages of photomutiplier tubes utilized as photodetectors in a multi-color flow cytometer in accordance with aspects of the subject innovation.

FIG. 8 illustrates an example predicted spectral overlap matrix and associated predicted fluorescence signal strengths in accordance with aspects described herein.

FIG. 9 displays a flowchart of an example method for calibrating initial amplification control parameters in photodetectors for multi-color fluorescence flow cytometry according to aspects of the subject innovation.

FIG. 10 is a flowchart of an example method for accepting a set of calibrated amplification control parameters according to aspects of the subject innovation.

FIG. 11 illustrates various relevant supporting information and details of aspects of the innovation.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the innovation. It may be evident, however, that the innovation may be practiced without these specific details. In other instances, well-known structures and devices are shown in block diagram form in order to facilitate describing the present innovation.

As employed in this application, the terms “component,” “system,” “platform,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is in turn operated by a software or firmware application executed by a processor, wherein the processor can be internal or external to the apparatus and executes at least a part of the software or firmware application. As yet another example, a component can be an apparatus that provides specific functionality through electronic circuitry without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

System(s) and method(s) provided in the subject innovation enable configuration of amplification parameters of a plurality of photodectors with digital electronics utilized in a flow cytometer. Configuration is iterative and optimizes calibration of amplification control parameters subject to constraints that ensure satisfactory, e.g., optimal, spectral compensation. In an aspect, iterative configuration can include at least a first loop for constrained minimization of spectral overlap for a set of operational condition, and a second loop primarily being an acceptance loop. At least five criteria can be defined and utilized in calibration: (i) Minimize the coefficient of variation of negative population(s); (ii) At least a predetermined, configurable portion of unstained events are on-scale, which affords an accurate measurement of median or mean fluorescence intensity; (iii) The brightest stained events are on scale; (iv) Spectral compensation between all fluorescence channels is minimized with no spectral matrix coefficients, or spillover coefficients, above a predetermined configurable threshold; and (v) A spillover metric that assesses a degree of spectral overlap in multi-color photon emission measurements are minimized with restriction to constraints (ii)-(iv); the spillover metric can be the sum of squares of spillover coefficients. Aspects and features of the subject innovation are described in greater detail below. The following abbreviations are relevant at least in part to the subject specification:

A700 Alexa Fluor 700

AC7 APC Cy7

APC Allophycocyanin

Cy5 Cyanine 5

Cy7 Cyanine 7

Cy5.5 Cyaninin 5.5

CFSE Carboxyfluorescein Diacetate Succinimidyl Ester

ECFP Enhanced Cyan Fluorescent Protein

EYFP Enhanced Yellow Fluorescent Protein

FITC Fluorescein-isothiocyanate

GFP Green Fluorescent Protein

Ig Immunoglobulin

PC5 PE-Cy5

PC7 PE-Cy7

PE Phycoerythrin

PI Propidium iodide

PerCP Peridinin Chlorophyll Protein

VB Violet laser, blue emission (Pacific Blue)

VY Violet laser, yellow emission (Cascade Yellow)

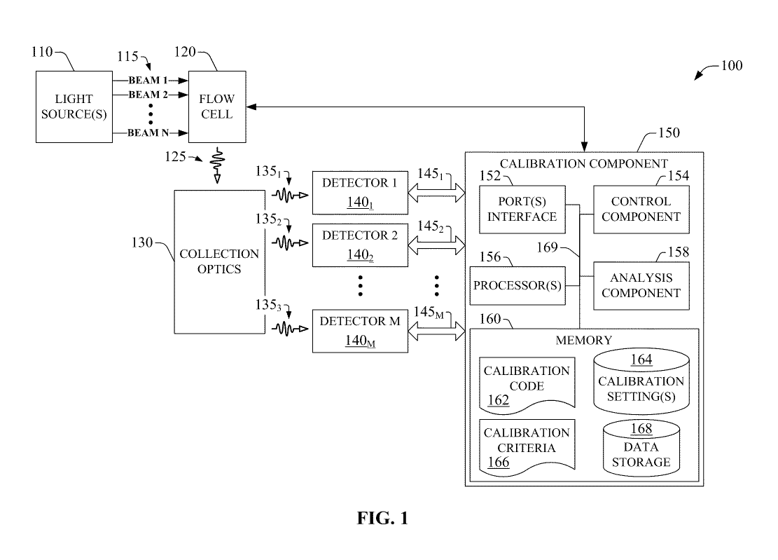

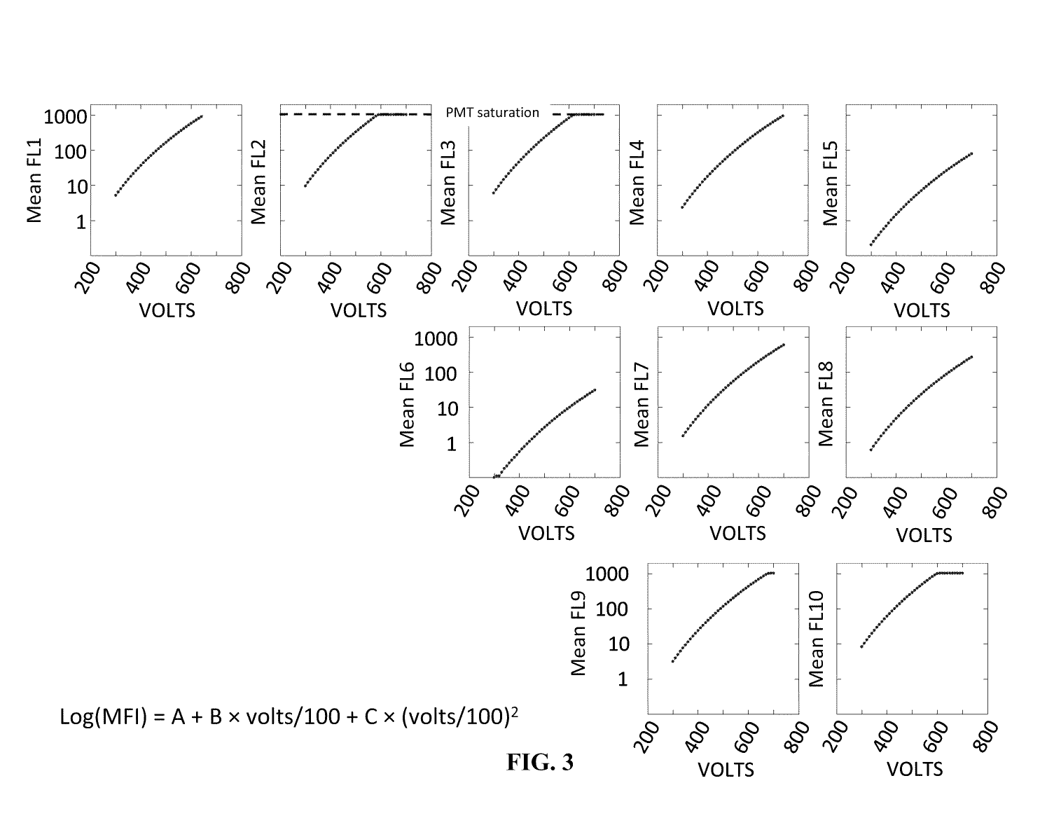

Referring now to the drawings, FIG. 1 illustrates an example system 100 that can optimize a set of initial amplification control parameters for each detector in a set of detectors for multi-color, multi-channel flow cytometry in accordance with aspects described in the subject innovation. It is noted that FIGS. 3-8 are referenced where appropriate to illustrate aspects and features of example system 100. Example system 100 represents a flow cytometer functionally coupled with a calibration component 150.

Flow cytometer includes light source(s) 110, which can deliver a set of N light beam(s) 115; N is a natural number that generally can range from 1-10. Disparate light sources can be included within light source(s) 110 and produce one or more of beams 115; for instance, light sources can include diode lasers in a variety of wavelengths, a tunable Ar-ion laser, a Kr-ion laser, a dye laser, a tunable He—Ne laser, He—Cd laser, or halogen lamp(s) such as a Hg lamp or Xe lamps, quantum dot-based laser, etc. Light beam(s) 115 can probe cells flowing single file through a flow cell 120. Light source(s) 110 can include optics associated with optic elements (e.g., lenses, prisms) that direct or focus light onto a specific area of flow cell 120.

Conventionally, probed cells are stained, e.g., at least partially coated, with one or more fluorochromes that enable fluorescence emission 125 as a result of radiative recombination of electro-hole pairs excited with probe beam(s) 115. Generally, disparate fluorochromes are excited and emit photons in disparate regions of the electromagnetic spectrum. In addition, due to inhomogeneous broadening, fluorescence 125 is not composed of a set of spectrally non-overlapping narrow bands originated from the one or more fluorochromes that stain the probed cells, proteins, lipids, or other soft tissue that passes through flow cell 120; instead, fluorescence 125 is spectrally broad with one or more main bands. Accordingly, photon emission of disparate fluorochromes spectrally overlaps.

Fluorescence 125 is gathered through collection optics 130, which can include optical elements such as lens(s) for beam focusing or collimation of fluorescence 125; beam splitters such as dichroic minors for collimated beam splitting; and band-pass filters, or other type of filters, that define fluorescence channels FLk (k is a natural number) associated with photons directed to detector k, with k=1, 2, . . . M; detectors 140k can belong to a same class, e.g., detectors 140₁-140_{M} are photomultipliers (PMTs), or to disparate classes, e.g., detectors 140₁, 140₂, 140₃ are PMTs and detectors 140₄-140_{M} are charge coupled device (CCD) cameras. Fluorescence data can be retained in data storage 168; however, it should be appreciated that most any data associated with calibration of control parameters of photodetectors 140ₖ, as described herein, can be stored in data storage 168.

Utilization of disparate detection instrumentation can be based at least in part on relative intensities expected for disparate, dim positive populations of stained cells. Fluorescence channel FLk is characterized by a center wavelength λₖ, or energy Eₖ, and a spectral width Δνₖ; λₖ or Eₖ is characteristic of fluorescence spectrum of fluorochrome k. It is noted that in multi-color configurations, e.g., M>1, light beam 135ₖ incident onto detector k 140ₖ includes photons emitted from fluorochromes 1 through k−1 and k+1 through M; such photons can give rise to spectral spillover and related negative population, as described below.

Detector k (140), also referred herein as photodetector k, includes circuitry that enables fluorescence signal such as pre-amplifier(s), amplifier(s), analog-to-digital conversion elements, or the like. Circuitry in a detector 140 is generally specific to the type of photodetector employed in photon collection; e.g., a photomultiplier tube generally has circuitry that differs at least in part from a CCD camera, or a photodiode. Regarding PMTs, received photons trigger a stream of electrons that can be multiplied in accordance with an applied voltage. Such voltage acts as an amplification control parameter (ACP) and can be tuned to calibrate PMT sensitivity. In addition, a PMT includes an analog-to-digital signal (ADS) converter that can channelize, e.g., assign a channel number to magnitude of signal strength such as voltage pulse heights, area under a pulse, or pulse time spread associated with received photons at the PMT. Other types of photodetectors also can display a set of one or more ACPs which can be tuned during calibration.

In an aspect of the subject innovation, calibration component 150 enables adjustment of one or more ACPs for detectors 140₁-140_{M}. To at least that end, calibration component 150 includes a port(s) interface 152 that is operationally attached to links 145₁-145_{M} that allow exchange of data and signaling with respective detectors 140₁-140_{M}. Port(s) interface 152 can include a general purpose input/output card, a GPIB card, a universal serial bus (USB) connector, a RS-232 serial interface; links 145ₖ can include FireWire cable(s), USB cable(s), RS-232 cable(s), USB cable(s), etc. Exchanged data can include pulse voltages generated through photon detection at a photodetector, e.g., a PMT.

Control component 154 can configure one or more ACPs, e.g., voltage magnitudes, in detectors 140ₖ-140_{M}, and can collect data there from, the data can be relayed to analysis component 158 that conducts at least a portion of analysis associated with detector calibration in accordance with calibration criteria 166 retained in memory 160, and discussed herein below. ACP configuration includes communication of signaling to detectors 140₁-140_{M} through port(s) interface 152 and links 145ₖ. It should be appreciated that data control effected by control component 154 and data analysis implemented through analysis component 158 can be implemented at least in part through execution of calibration code 162 stored in memory 160.

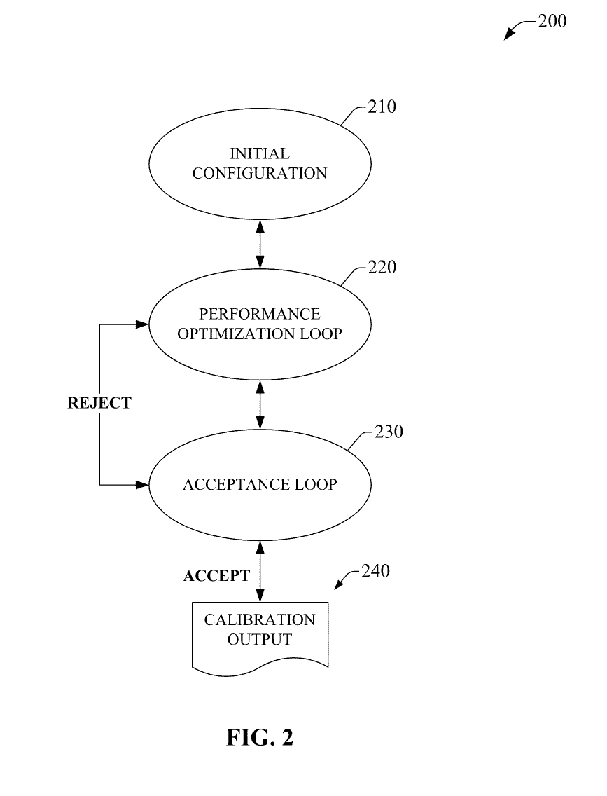

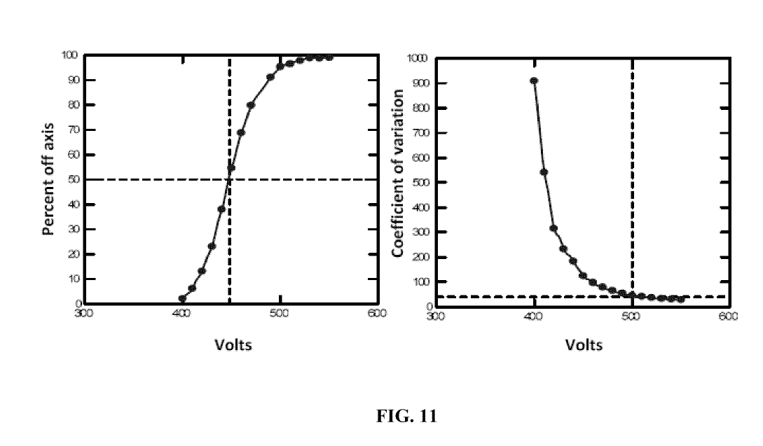

Calibration component 150 and components therein, exploit a calibration logic, an example of which is schematically represented in FIG. 2. An initial configuration 210 is administered by control component 154; data collected in connection with the initial configuration 210 is processed through analysis component 158. In aspects, determination of the starting PMT voltages is accomplished at least in part by probing unstained peripheral blood lymphocytes as control samples; unstained peripheral blood cells can be acquired within a lymphocyte light scatter gate. For each fluorescence parameter, e.g., FLk, the PMT voltage can be increased in 10 V increments and the percentage of events falling on scale and the coefficient of variation (CV) of the peak can be determined; see FIG. 11, wherein results are shown for FL1 PMT, which was set up to measure green emitted light.

At the lowest voltage tested, most of the cells were off scale (e.g., counts accumulated in the first channel in the digital detection instrument) and the associated CV was high. At about 450 V nearly half of the unstained blood cells were on scale, yet, the CV remained relatively high. Further increase of voltage to 500 V reduced resulting CV to its nearly lowest point. Thus, through minimization of the CV of measured fluorescence of unstained cell, an initial voltage can be extracted for a photodetector (e.g., 140₁), which can detect FL1 emitted photons. It is noted that an initial voltage value for other PMT detectors 140 can be obtained in a similar manner. Initial voltage configurations obtained through minimization of CV and restriction of negative population(s) to be on-scale are approximate and generally do not provide a satisfactory initial calibration for complex, multi-color probes.

When initial configuration 210 is complete, a set of ACPs, e.g., pre-amplifier voltage, for each detector 140ₖ is established. Initial ACPs configuration is optimized through a performance optimization loop 220. In an aspect, performance optimization loop 220 starts with characterization of fluorescence signal strength F as a function of a set of ACPs for each detector 140ₖ: F=F (γ₁^{(k)}, γ₁^{(k)} . . . , γ_{Q}^{(k)}), wherein γ₁^{(k)} with I=1, 2 . . . Q (Q a natural number) is an ACP in the set of ACPs. This relationship is particular to the individual detector 140ₖ and individual instruments, such as collection optics associated with the detector 140k or detection circuitry associated therewith. The relationship can be determined one time; however, in general, the relationship can be determined when specific calibration conditions are fulfilled; for instance, after a specific number of hours of operation of the detector.

In a scenario in which each detector 140ₖ is a PMT, a single ACP γ₁^{(k)}=V, with V a voltage applied to the PMT, can be included in the characterization F=F (V). Analysis component 158 can determine the relationship between fluorescence signal strength and voltage configured for PMT operation. In an aspect, fluorescence signal strength F can be quantified via a geometric mean fluorescence intensity (MFI) or a function thereof; for instance log(MFI). In an aspect, the geometric MFI is computed based at least in part on collected fluorescence data in a 1-parameter histogram for fluorescence signal counts in a set of detection channels, e.g., 1024 channels. It should be noted that other mean types can be computed and utilized as a measure of fluorescence signal strength, such as an arithmetic mean or a weighted mean.

As a specific non-limiting example, for a PMT detector 140ₖ for fluorescence channel FLk, control component 154 can increase applied voltage to the PMT in ΔV increments, e.g., 10 Volt increments, and record the resulting geometric MFI for fluorescence signal collected for a samples composed of standard control beads, e.g., FlowSet beads from Beckman Coulter of Miami, Fla. Such scan measurements can allow determination of the response of the detector 140ₖ to fluorescence signal in channel FLk. In an aspect, scan measurements are conducted with each detector in the set of detector 140₁-140_{M}, and intensity, or signal strength, data for fluorescence 125₁-125_{M} in respective channels FL1-FLM is recorded.

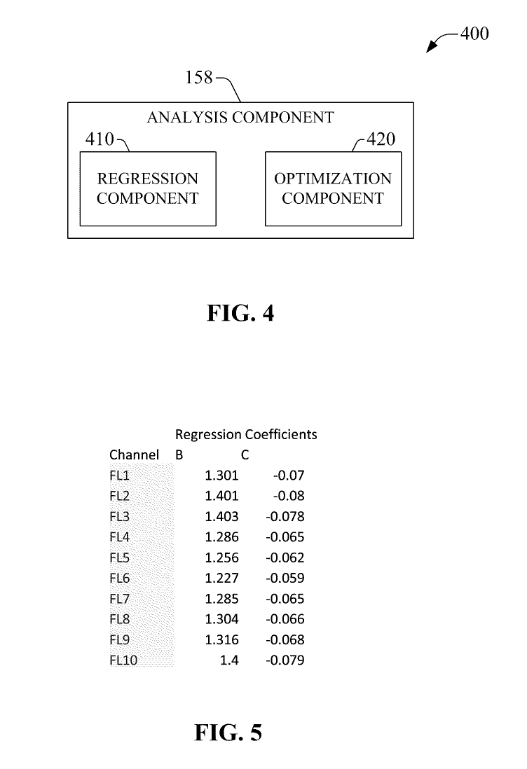

FIG. 3 displays example fluorescence intensity as a function of voltage for fluorescence of control beads in M=10 fluorescence channels. With exception of voltage intervals that result in signal intensity saturation, the relationship log(MFI)=f (V) can be modeled well by a parabola log(MFI)=A+B×ν+C×ν², where v=V/100 is a reduced voltage and A, B, and C are real number coefficients. Analysis component 158 can adjust, or fit, parameters A, B, and C through non-linear regression. In an aspect, in the example embodiment of component 158, illustrated in FIG. 4, analysis component 158 can discard data for measurements that saturate the PMT detector, e.g., FL2, FL3, FL9, FL10, or fluorescence is not detected, e.g., FL6, and exploit a regression component 410 to implement a least squares linear regression to extract coefficients A, B and C. Resulting regression coefficients for data in FIG. 4 are presented in tabular form in FIG. 5.

It is noted that regression component 410 can implement other linear or non-linear regression algorithms, which can be stored in memory 160, to determine a functional relationship for fluorescence signal strength as a function of voltage applied to the PMT. It is noted that regression component 410 can extract parameters that determine most any, or any, functional relationship F=F(γ₁^{(k)}, γ₁^{(k)} . . . , γ_{Q}^{(k)}), as described above.

Referring again to the example of FIG. 2, performance optimization loop 220 can also include generation of a spectral overlap matrix, or spillover matrix. To at least that end, in an aspect, a set of voltages for PMT detectors 140₁-140_{M} calibrated in initial configuration 210, as described above, are utilized to acquire single-stained compensation standards such as at least one of integrally stained beads for FITC, PE, APC or other single dyes or non-tandem dyes; or fluorochrome conjugated antibody stained Ig capture beads for tandem dyes, e.g., PE-Texas red, PE-Cy5, PE-Cy7, APC-Cy5.5, APC Alexa 700, APC-Cy7 or the like. It is noted that the tandem dyes should be in optimal, or nearly optimal, condition with minimal spillover into the photon donor channel (e.g., minimal PECy7 spillover into the PE channel).

From the foregoing acquisition of fluorescence data, an observed spectral overlap matrix that assesses spillover of fluorescence channel A into fluorescence channel B can be determined. In an aspect, a spectral overlap matrix is composed from MFI values for a bead stained with fluorochrome A and a bead stained with fluorochrome B, wherein a matrix element

$${M}_{AB} = \frac{{MFI}_{B}}{{MFI}_{A}} ,$$

where MFI_{A} and MFI_{B} are, respectively, geometric mean fluorescence intensity values for fluorochrome A and B. It should be appreciated that diagonal matrix elements are equal to 1 by definition.

To determine an observed spectral overlap matrix, control component 154 communicates with signal detectors 140₁-140_{M} to acquire fluorescence signal for a first stained bead with nominal primary emission in channel FLp and fluorescence data is collected. Signal strength is computed, by analysis component 158, for example. Such measurement and analysis typically result in a strong signal at channel FLp and spillover signal in channels FL1-FL(p−1) and FL(p+1) through FLM. Subsequently, control component 154 signals acquisition of fluorescence for a second stained bead with nominal primary emission in channel FLq, data is collected and signal strength is determined. Analysis component 158 can compute M_{AB} and format the spectral overlap matrix. It is to be appreciated that other definitions of M_{AB} that gauge relative fluorescence signal strength in channel B with respect to channel A can be utilized. It should also be appreciated that spectral overlap matrix is determined by at least one of ACP settings of each detector employed in acquisition of fluorescence signal or emission spectrum of stained control samples, e.g., beads, employed to acquire fluorescence signal.

As part of optimization loop 220 of FIG. 2, analysis component 158 evaluates the observed spectral overlap matrix to establish matrix elements that are above a predetermined, configurable threshold; for instance, such threshold can be 0.40 or 40%. It should be appreciated that the number of matrix elements above a threshold is determined by the voltage settings utilized for PMT detectors 140₁-140_{M}.

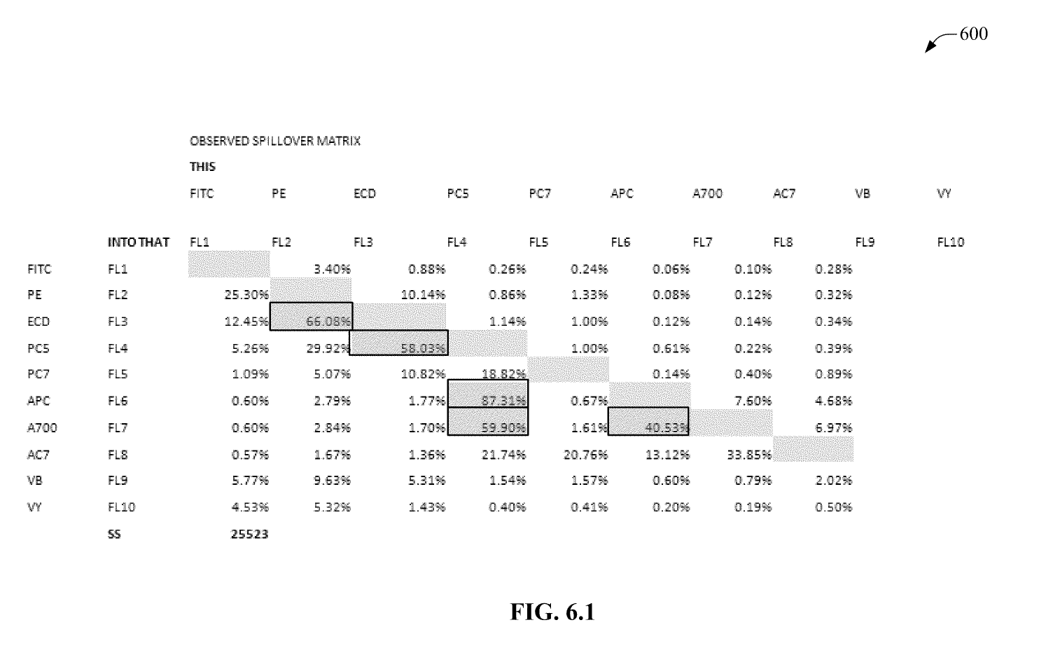

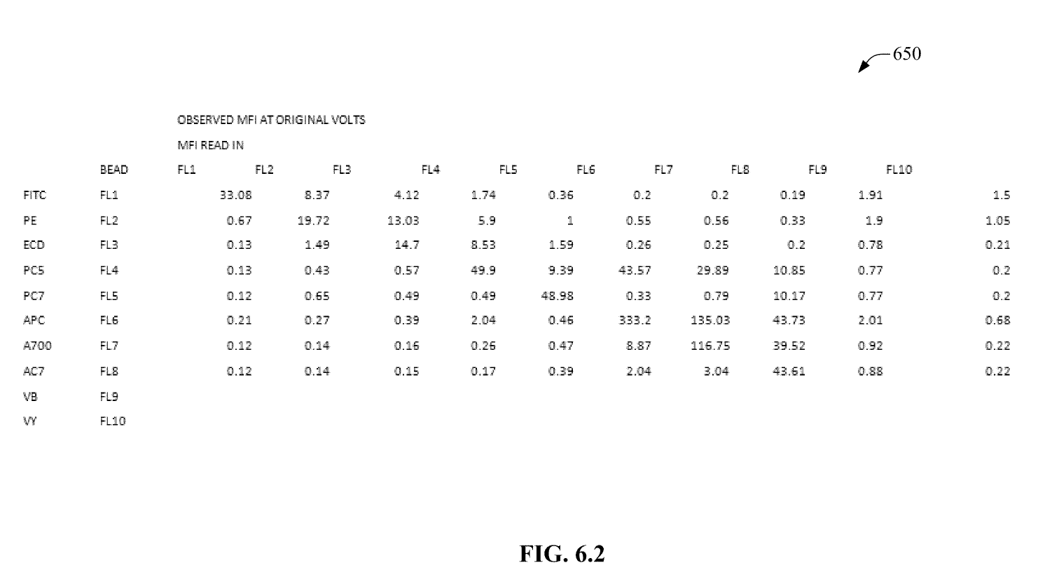

FIG. 6 illustrates an example spectral overlap matrix in panel 600 for ten stained beads in a 10-color cytometer with ten PMT detectors configured at voltage settings determined in initial configuration loop 210. In panel 600, five matrix elements, marked in red and boxed, are above threshold, which indicates that five of the initial voltage settings are out of range. Panel 650 displays a matrix of fluorescence signal strengths.

In addition, a spillover metric can be defined or otherwise calculated, wherein the spillover metric determines a quality of spectral compensation afforded by the set of values for the set of ACPs associated with the set of respective photodetectors. In an aspect, the spillover metric (S) can be a sum, over all computed matrix elements, of squares of M_{AB}s, e.g., ΣM_{AB}², or a sum, over all computed matrix elements, of squares of percentage-based matrix elements, e.g., Σ(100×M_{AB})². As an example, in panel 600, a spillover metric S associated with the displayed spectral overlap matrix is indicated as SS. As part of performance optimization loop 220, the value of SS is minimized as described below.

In the optimization loop 220 of FIG. 2, generation of an initial spectral overlap matrix and associated spillover metric S is a first iteration in a set of iterations that intend to minimize S while maintaining spectral overlap matrix element below the preconfigured threshold, and retaining voltage settings or ACPs settings that ensure (i) at least 50% of unstained events are on-scale, which permits an accurate measurement of mean or median fluorescence intensity since such measurements requires that all events be on scale. It is noted that, in an aspect of the subject calibration criteria, PMT voltages that put 80% of unstained cells off-axis are preferably selected, whereas voltage(s) that leads to 50% of unstained cells off-axis is identified as a lower limit of acceptable PMT voltage. It is also noted that when lasers in the red (boxed) range (e.g., laser wavelength above 620 nm) are utilized, autofluorescence of unstained cells may be so low as to preclude putting 50% of cells on scale, in which case a less stringent criterion (e.g., 20% threshold) can be employed. (ii) The brightest stained events are on scale. Criteria (i) and (ii) and constraint on spectral overlap matrix elements comprise calibration criteria or optimization criteria, which can be retained in memory component 160. Optimization component 420 of FIG. 4 can maintain criteria (i) and (ii) throughout the iterative calibration described herein.

To continue performance optimization loop 220, control component 154 adjusts, e.g., increases of decreases, voltages of PMT detectors 140₁-140_{M}, and exploits analysis component 158 to predict signal strength for each of the PMT detectors at the adjusted voltage. In an aspect, magnitude of adjustment can be determined through an optimization component 420 in an example embodiment of analysis component 158, as illustrated in FIG. 4; for instance, optimization component can determine adaptive adjustment of configured voltages, or ACPs, or other update strategies based at least in part on the number of ACPs that are configured in a photodetector, or the number of ACPs associated with a plurality of detectors that are adjusted simultaneously; and the algorithm (e.g., Newton-Gauss, conjugate gradient) employed to carry out a minimization of the spillover metric S.

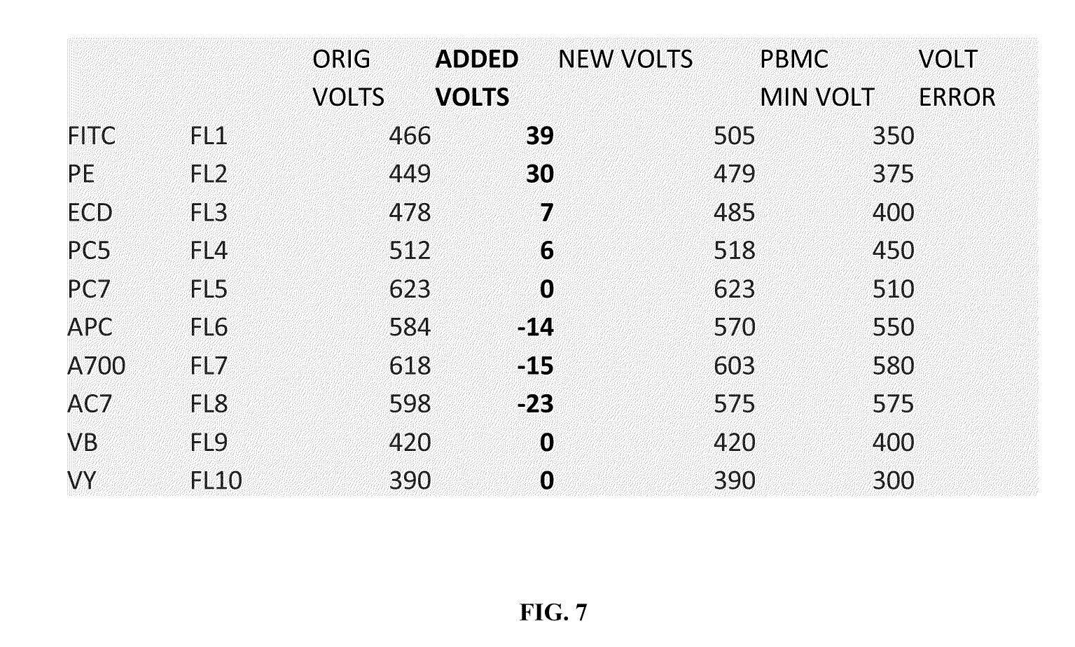

Optimization component 420 also can exploit, at least in part, artificial intelligence techniques, or machine-learning approaches, to voltage update strategy as well as other aspects of automatic calibration described herein. It is noted that optimization component 420 can be retained in calibration code 162. In another aspect, voltage update can be implemented one voltage at a time, for a related photodetector and fluorescence channel; the initial voltage that is updated can correspond to a pair of fluorescence channels that display the largest spectral matrix coefficient. It should be appreciated that control component 154 can update substantially any set of ACPs per photodetector 140ₖ, wherein the ACPs for the photodetector allow prediction of fluorescence signal strength for the updated ACPs. An example initial (extracted from initial configuration 210) and adjusted voltages for PMT detectors are shown in FIG. 7.

For a set of adjusted, or updated, voltages of PMT detectors 140₁-140_{M}, analysis component 158 predicts updated fluorescence signal strength based at least in part on the regression coefficients B and C (FIG. 5) extracted from the fitted relationship log(MFI)=A+B×ν+C×ν², and an update recursion expression. In an aspect, the update recursion expression can be

log(MFI)_{J}=log(MFI)_{J-1}+B×(ΔV_{J}/100)+C×(ΔV_{J}/100)², with J=0, 1 . . . J_{MAX,}

where log(MFI)_{J-1} is a fluorescence signal strength determined at a previous iteration J-1 (a natural number), which at J=0 corresponds to the originally observed MFI at initial voltage settings (e.g., V₀) as established in initial calibration 210; and offset ΔV_{J}=V_{J}−V_{J-1}, is the difference between updated voltage and previous voltage, see, e.g., FIG. 7; and J_{MAX} is a maximum number of allowed iterations. Predicted MFI at iteration J results from 10^{log(MFI)}.

In the optimization loop 220, predicted MFI at the updated voltage settings are employed to calculate a predicted spectral overlap matrix and associated spillover metric; as discussed above, analysis component 158 can perform such calculation(s). Spectral matrix coefficients are compared with respect to the predetermined threshold (e.g., 40%) and updated spillover metric S_{J} is evaluated to determine if it is at a minimum; such evaluation typically includes comparison of S_{J} with respect to S_{J-1} and a predetermined tolerance and sign of the difference S_{J}−S_{J-1}.

When spectral matrix coefficients are above threshold or SJ is not at a minimum, control component 154 updates voltages, or any other ACP employed for calibration of a photodetector. Voltages are updated based at least in part on calibration criteria described above; for instance, updated voltages can be bound to remain above minimum voltage values established in initial calibration 210. In an aspect, control component 154 can reduce spectral overlap matrix coefficient M_{PQ}, of P fluorescence into Q fluorescence through increase of the voltage of detector 140p or decrease of voltage of detector 140_{Q}.

It is noted that after successive iterations, e.g. voltage updates, spectral matrix elements M_{AB} for a set of fluorescence channels and associated detectors can adopt values below threshold, while spillover metric has not converged to a minimum. Control component 154 can continue optimization through further adjustment of voltages until spillover metric, e.g., sum of squares of matrix elements M_{AB}, converges to a minimum. It is noted that for each fluorescence channel there is a voltage that minimizes the spillover metric; e.g., the sum of squares.

When iterative voltage adjustment, as described herein, implemented at least in part through control component 158, the set of converged, predicted voltages for respective detectors in the set of detectors is configured as the correct, optimized voltage settings for a given instrument, e.g., cytometer, with a specific set of fluorochromes. Prior to acceptance of predicted voltages, or ACPs, such converged, optimized voltage settings are tested on a set of single stained compensation beads disparate from the beads employed to generate data for the first iteration in performance optimization loop 220, and the voltage settings and resulting fluorescence signal strength, e.g., MFI, are evaluated. Control component 154 can configure, at least in part, for disparate beads to be drawn into the flow cell 120; for instance, control component 154 can command an exchange chamber to replace beads utilized in measurements that are part of the calibration described herein.

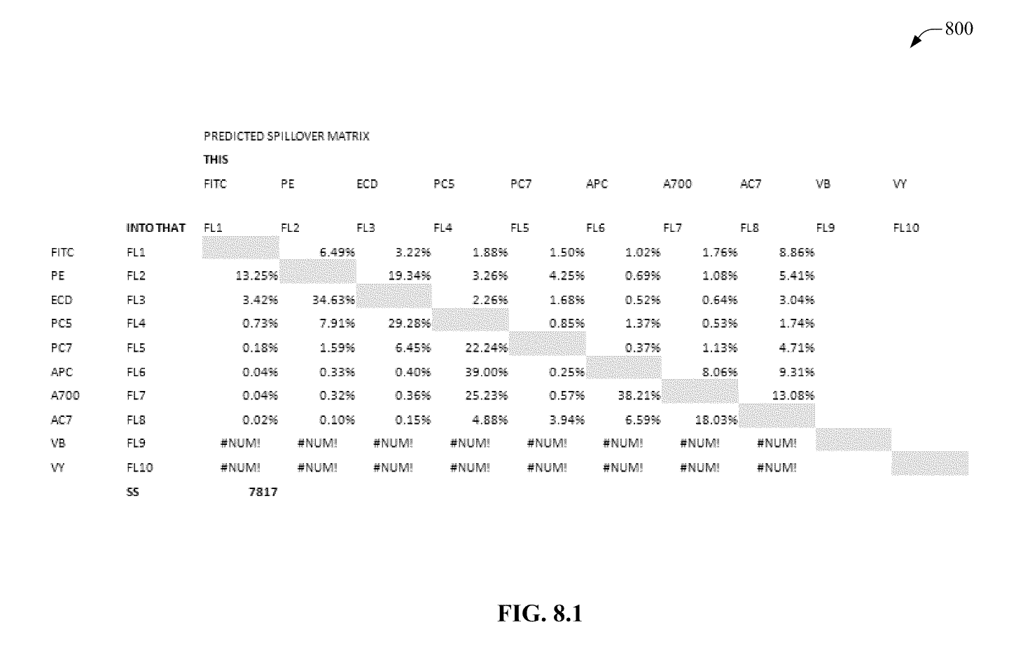

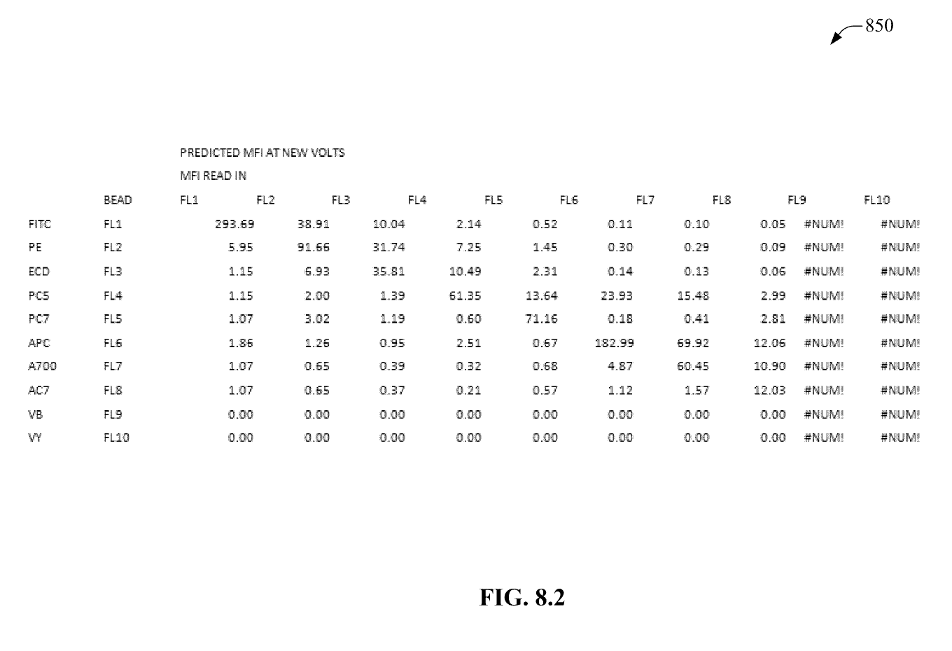

The observed spectral overlap matrix (top table) is compared with the predicted spectral overlap matrix; see panel 850 in FIG. 8. If all observed spectral overlap matrix coefficients are smaller than the preconfigured threshold, e.g., 40%, optimization of instrument performance is complete and voltage settings are accepted, through acceptance loop 230, and conveyed as calibration output 240; the voltage settings can be retained in voltage setting(s) 164. If there is significant disagreement between the predicted and observed spectral overlap matrices, current settings are rejected, and voltages and a new set of predicted voltages, or other ACPs, are iteratively obtained as described above.

Completion of performance optimization loop 220 results in an optimized voltage for each PMT detector, such that the optimized voltages when applied to respective PMT detectors can minimize spectral overlap, e.g., fluorescence signal spillover, among the multiple fluorescence channels FLk utilized in the multi-color cytometer in example system 100. In addition, at optimized PMT voltage settings, bead target channels are determined and employed, rather that employing optimized PMTs, to reproduce settings in subsequent experiments. Configuration of optimal PMT settings provided identical constraints in conjunction with the use of bead target channels enables transferability settings among disparate flow cytometers, e.g., at disparate clinics or laboratories, that exploit the same fluorescence channels as probes.

It is noted that photodetector calibration as described herein can be applied to identify a set of one or more optimal ACPs for each photodetector 140ₖ based at least in part on specific detection operation of the photodetector.

A processor(s) 156 can confer at least in part the functionality of components in example system 100. To such end, the processor can execute code instructions, e.g., calibration code, stored memory 160, or in substantially any memory in any location that is functionally coupled to the processor(s) 156. Alternatively, or in addition, one or more components of example system 100 can reside at least in part within memory 160, and the processor can execute such components to exploit their functionality. Processor(s) 156 is functionally coupled to each component in calibration component 150 via a bus 169, which can include a memory bus, an address bus, a system bus, etc.

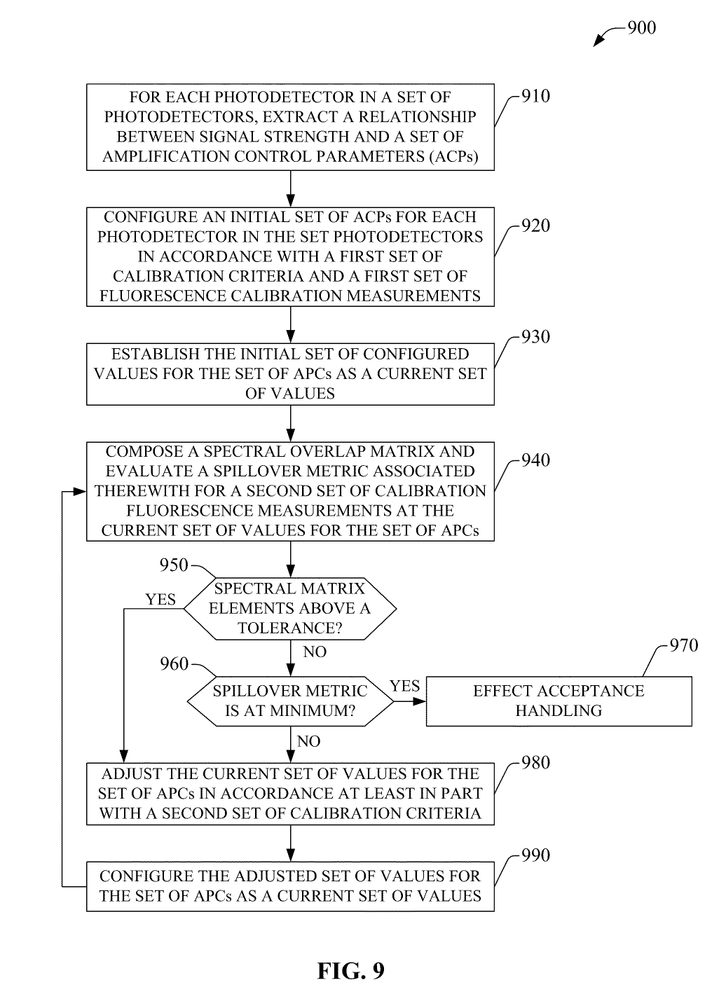

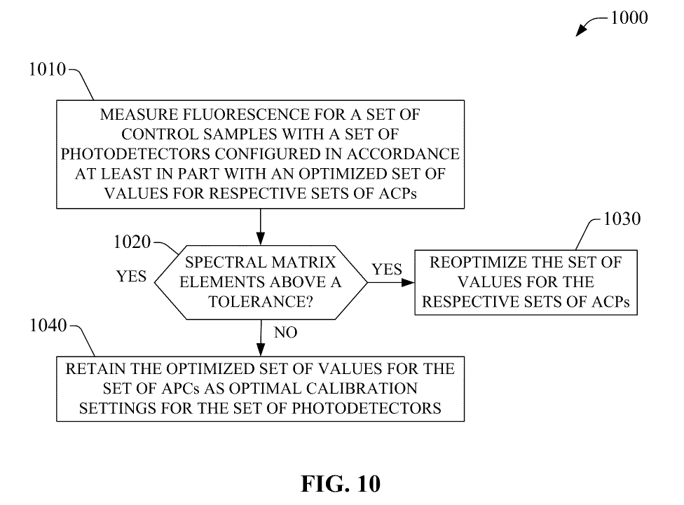

In view of the example system(s) shown and described above, an example method that can be implemented in accordance with the disclosed subject matter will be better appreciated with reference to the flowcharts of FIGS. 9-10. While, for purposes of simplicity of explanation, the example method is shown and described as a series of acts, it is to be understood and appreciated that the disclosed subject matter is not limited by the number or order of acts, as some acts may occur in different order(s) or concurrently with other acts from what is depicted and described herein. Moreover, not all illustrated acts may be required to implement the methods described hereinafter. It is to be appreciated that the functionality associated with the acts may be implemented by software, hardware, firmware, a combination thereof or any other suitable means (e.g., device, system, process, component). It is to be understood and appreciated that that a method can be alternatively represented as a series of interrelated states or events, such as in a state diagram or interaction flow. It should be further appreciated that the method(s) disclosed hereinafter and throughout this specification can be stored or packaged on an article of manufacture (e.g., a computer-readable medium with instructions stored thereon) for utilization of the disclosed methods, such as transportation or transfer of such methods to various devices, execution of the methods, commercialization thereof, and so forth.

FIG. 9 displays a flowchart of an example method 900 for configuring initial amplification control parameters for a set of photodetectors for each fluorescence parameter in a multi-color flow cytometer. One or more components such as calibration component (e.g., 150 of FIG. 1), and components therein, in addition to a set of photodetectors, can enact the subject example method 900. Alternatively or additionally, a processor that confers at least part of the functionality to the one or more component also can enact at least a portion of the subject example method through execution of code instructions (e.g., calibration code 162) retained in a memory functionally coupled to the processor. At act 910, for each photodetector in a set of photodetectors, a relationship between measured fluorescence signal strength, e.g., mean fluorescence intensity (MFI) in a digitally-recorded multi-channel fluorescence spectrum, and a set of amplification control parameters (ACPs) utilized in the measurement is extracted. The set of ACPs can include one or more parameters, which are typically germane to the type of photodetectors in the set of photodetectors; for instance, for a photomultiplier tube (PMT) an ACP can be voltage, which can be applied to a pre-amplifier in the PMT. Disparate photodetectors can include different ACPs based at least in part on the principle of photoconversion and operation of the detectors.

Linear or non-linear regression can be exploited to extract the subject relationship, which is pertinent to individual photodetectors, e.g., a PMTs, and individual associated instruments. In an aspect, in a PMT, MFI or a function thereof such as log(MFI) can be fitted as a quadratic function of operation voltage. For a specific detector and set of ACPs, the relationship is generally determined one time. It should be appreciated, however, that a relationship can be updated as a result of changes in experimental conditions such as the utilization of different optical filters, detector quality degradation, increase in detection noise, substantive changes in operation or measurement environment, etc.

At act 920, an initial set of ACPs for each photodetector in the set of photodetectors is configured in accordance with a first set of calibration criteria and a first set of fluorescence calibration measurements. In an aspect, the first set of fluorescence calibration measurements can include detection of unstained peripheral blood cells or other cells of interest acquired within an appropriate, or suitable, light scatter gate. The set of criteria can include at least one of minimization of the coefficient of variation (CV) of negative population fluorescence response, location of a predetermined portion of control samples (e.g., unstained lymphocytes) off axis, or the like. In an aspect, when the photodetectors are PMTs, a single voltage parameter spans the respective sets of ACPs. At act 930, the initial set of values for the set of ACPs is established as a current set of values. Establishing a current set of values for the ACPs includes communicating the current set of values to each detector in the set of photodetectors, and signaling or triggering operation according to such values is to be implemented during photodetection.

At act 940, a spectral overlap matrix is composed and a spillover metric associated therewith is evaluated for a second set of calibration fluorescence measurements at the current set of values for the set of ACPs. It should be appreciated that detection performance is dictated at least in part by the current set of ACPs.

At act 950, it is evaluated if spectral overlap matrix elements are above a configurable, predetermined threshold (e.g., 0.40 or 40%). In an aspect, the one or more component(s) that enact the subject example method, or a processor associated therewith, can perform evaluation in act 950 nearly simultaneously with generation of spectral overlap matrix in act 940. When outcome of evaluation act 950 is positive, flow is directed to act 980. Conversely, in a negative outcome in act 950, leads to act 960, in which it is evaluated if the spillover metric is at, or nearly at, a minimum.

A negative outcome of act 960, leads to act 980 in which the current set of values for the set of ACPs is adjusted in accordance at least in part with a second set of calibration criteria. At act 990, the adjusted set of values for the set of ACPs is configured as a current set of values, and flow is redirected to act 940 for an additional iteration of composition and evaluation. As described above, configuration in act 990 includes communicating the adjusted set of values of ACPs to each detector in the set of photodetectors, and signaling or triggering operation according to such values is to be implemented during photodetection.

A positive outcome of act 960 leads to 970, in which acceptance handling is effected. Such handling includes testing of the set of values for the set of ACPs that minimize the spillover metric. FIG. 10 displays a flowchart of an example method 1000 for effecting acceptance handling of an optimized set of ACPs for a set of respective photodetectors in a multi-color flow cytometer. One or more components such as calibration component 150, and components therein, in addition to a set of photodetectors, can enact the subject example method 1000. Alternatively or additionally, a processor that confers at least part of the functionality to the one or more component(s) also can enact at least a portion of the subject example method through execution of code instructions (e.g., calibration code 162) retained in a memory functionally coupled to the processor. At act 1010, fluorescence is measured for a set of control samples with a set of photodetectors configured in accordance at least in part with an optimized set of values for a set of respective ACPs.

At act 1020, it is determined if a spectral overlap matrix elements extracted from the measurements in act 1010, are above a predetermined tolerance. In the affirmative case, the set of values for the respective sets of ACPs is re-optimized at 1030. Re-optimization can proceed at least in part according to at least a portion of example method 900. Conversely, in the negative case, at act 1040, the optimized set of values for the set of ACPs is retained as optimal calibration settings for the set of photodetectors; for instance settings are stored in a memory element such as calibration setting(s) 164, e.g., a volatile or non-volatile memory component such as for example a random access memory. It is noted that at 1040, each detector in the set of detectors operates at the optimized values of the set of ACPs. Optimization of operational values of ACPs for the set of detectors in multi-color cytometry terminates at act 1040.

Referring now to FIG. 11, there are illustrated examples of relevant supporting information and details of aspects disclosed herein. More particularly, FIG. 11 displays percentage of off-axis negative events and coefficient of variation (CV) of negative population distribution for a green-fluorescence channel detected with a photomultiplier tube in accordance with aspects of the subject innovation.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for calibrating a set of photodetectors in a multi-color flow cytometer, the method comprising:
employing a processor to execute code instructions stored in a memory, the code instructions when executed by the processor implement the following acts:
iteratively adjusting a set of amplification control parameters (ACPs) for each photodetector in the set of photodetectors to establish a current set of values for the set of ACPs; and
for each iteration, composing a spectral overlap matrix and evaluating a spillover metric associated therewith for a set of calibration fluorescence measurements at the current set of values for the set of ACPs, and, when a set of elements of the spectral overlap matrix are below a tolerance and the spillover metric is at a minimum, effecting acceptance handling, wherein acceptance handling includes:
measuring fluorescence for a set of control samples with the set of photodetectors configured in accordance at least in part with the adjusted set of values for respective sets of ACPs; and, when a set of elements of the spectral overlap matrix are below the tolerance, retaining the adjusted set of values for respective sets of ACPs as optimal calibration setting for the set of photodetectors.

2. The method of claim 1, wherein iteratively adjusting a set of amplification control parameters (ACPs) for each photodetector in the set of photodetectors to establish a current set of values for the set of ACPs includes:
configuring an initial set of ACPs for each photodetector in the set of photodetectors in accordance with a first set of calibration criteria and a first set of fluorescence calibration measurements; and
increasing or decreasing each value in the current set of values for the set of ACPs according to an update strategy.

3. The method of claim 2, further comprising for each photodetector in the set of photodetectors, extracting a relationship between fluorescence signal strength (FSS) and a set of amplification control parameters (ACPs).

4. The method of claim 3, for an initial iteration, composing the spectral overlap matrix includes:
acquiring multi-color fluorescence for single-stained compensation standards; and
extracting a spectral overlap matrix element for overlap of a first fluorescence channel into a second fluorescence channel as a ratio of an FSS for the second channel and an FSS for the first channel.

5. The method of claim 4, wherein single-stained compensation standards include at least one of integrally stained beads for FITC, PE, APC (and other non-tandem dyes), or fluorochrome conjugated antibody stained Ig capture beads for tandem dyes.

6. The method of claim 4, for each iteration subsequent to the first iteration, and for each fluorescence channel, composing the spectral overlap matrix includes:
predicting an FSS value based at least in part on a set of regression coefficients resulting from extracting the relationship between fluorescence signal strength and a set of ACPs; and
computing spectral overlap matrix element for overlap of a first fluorescence channel into a second fluorescence channel as a ratio of a FSS for the second channel and a FSS for the first channel.

7. The method of claim 1, wherein the spectral overlap matrix comprises mean fluorescence intensity (MFI) values for a bead stained with at least two disparate fluorochromes.

8. An apparatus, comprising:
means for implementing an initial configuration of one or more amplification control parameters (ACPs) for each photodetector in a set of photodetectors;
means for iteratively optimizing the initially configured one or more ACPs, the optimization minimizes spectral compensation; and
means for effecting an acceptance evaluation of the optimized one or more ACPs for each photodetector in the set of photodetectors.

9. The apparatus of claim 8, further comprising means for retaining the optimized one or more ACPs for each photodetector in the set of photodetectors when the acceptance evaluation reveals spillover matrix coefficients extracted from multi-color measurements of a set of stained beads are below a predetermined threshold.

10. The apparatus of claim 8, wherein means for effecting the acceptance evaluation of the optimized one or more ACPs for each photodetector in the set of photodetectors includes means for rejecting the optimized one or more ACPs when spillover matrix coefficients extracted from multi-color measurements of a set of stained beads are above a predetermined threshold.

11. The apparatus of claim 10, wherein means for rejecting the optimized one or more ACPs includes means for requesting a re-optimization of the one or more ACPs.

12. A system for calibrating a set of photomultiplier tubes (PMTs) in a multi-color flow cytometer, the system comprising:
a control component that iteratively configures a voltage value for each PMT in the set of PMTs to establish a current set of voltage values;
an analysis component that, for each iteration, determines a spillover matrix and computes a spillover metric associated therewith for a set of calibration fluorescence measurements at the current set of voltage values; and
an optimization component that employs coefficients of the spillover matrix to one of accept or deny the current set of voltage values.

13. The system of claim 12, wherein, when the spillover matrix coefficients are below a tolerance and the spillover metric is at a minimum, the optimization component implements acceptance of the current set of voltage values wherein, to implement acceptance, the optimization component enables the following:
measurements of fluorescence for a set of control samples with the set of PMTs configured in accordance at least in part with the current set of voltage values; and
when spillover matrix elements are below the tolerance, storage of the current set of voltage values as optimal calibration settings for the set of PMTs.

14. The system of claim 12, wherein the tolerance is 40%.

15. The system of claim 12, the current set of voltage values are established via probe of unstained peripheral blood lymphocytes as a control sample.

16. The system of claim 12, wherein the spillover matrix assesses spectral overlap of fluorescence between disparate channels.

17. The system of claim 12, wherein the spillover matrix comprises MFI values for a bead stained with at least two disparate fluorochromes.

18. A computer-readable storage medium that retains code that, when executed by at least one processor, carries out the following acts:
iteratively adjusting a set of amplification control parameters (ACPs) for each photodetector in the set of photodetectors to establish a current set of values for the set of ACPs; and
for each iteration, composing a spectral overlap matrix and evaluating a spillover metric associated therewith for a second set of calibration fluorescence measurements at the current set of values for the set of ACPs, and when the spectral matrix elements are below a tolerance and the spillover metric is at a minimum, effecting acceptance handling, wherein acceptance handling includes:
measuring fluorescence for a set of control samples with the set of photodetectors configured in accordance at least in part with the adjusted set of values for respective sets of ACPs; and
when spectral overlap matrix elements are below the tolerance, retaining the adjusted set of values for respective sets of ACPs as optimal calibration setting for the set of photodetectors.

19. The computer-readable storage medium of claim 18, wherein the act of composing a spectral overlap matrix and evaluating a spillover metric comprises employing a plurality of predicted MFI values.

20. The computer-readable storage medium of claim 18, wherein the spectral overlap matrix comprises mean fluorescence intensity (MFI) values for a bead stained with at least two disparate fluorochromes.
